(19) United States
(12) Patent Application Publication
(10) Pub. No.: US 2015/0150032 A1
(43) Pub. Date: May 28, 2015

(54) COMPUTER ECOSYSTEM WITH AUTOMATIC "LIKE" TAGGING

(71) Applicant: SONY CORPORATION, Tokyo (JP)

(72) Inventor: Marc Steven Birnkrant, Poway, CA (US)

(73) Assignee: SONY CORPORATION, Tokyo (JP)

(21) Appl. No.: 14/091,932

(22) Filed: Nov. 27, 2013

(51) Int. Cl. H04N 21/442; H04N 21/4415; H04N 21/422; H04N 21/475; H04N 21/4223

(52) U.S. Cl. CPC H04N 21/44218; H04N 21/4758; H04N 21/4223; H04N 21/42203; H04N 21/4415; H04N 21/42201
USPC 725/12

(57) ABSTRACT

A consumer electronics (CE) device receives, from an imager and/or a microphone, an emotion signal representing an expression of a user of the CE device. Also, a biometric sensor generates a biometric signal representing a biometric parameter of the user of the CE device. Based on the emotion signal and biometric signal, a rating is determined that is related to content presented on the CE device at or near the time the emotion signal and biometric signal were generated.

### FIELD OF THE INVENTION

The present application relates generally to computer ecosystems and more particularly to automatic “like” tagging.

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

Present principles are directed to specific aspects of computer ecosystems, specifically, computing community or social network-style indications of user “likes” and “dislikes”, which currently require individual users to input. These indicators are popular because people are interested in other people's opinions, reviews, etc. As stated above, however, users are forced to provide their own input regarding their likes/dislikes or ratings of content, photos, comments, articles, etc.

### SUMMARY OF THE INVENTION

With the above recognitions in mind, present principles recognize the desirability for users to passively provide their feedback automatically without outside influence, distractions, etc. By doing this automatically, the sheer volume of feedback can increase dramatically. This feedback advantageously can be used by advertisers, content providers, recommendation engines, etc.

In examples, available personal sensor data and/or involuntary feedback such as facial expression, blood flow, perspiration, physical reactions, auditory reactions, etc. is collected, processed, and interpreted to develop a feedback model that can then be used by the content creator who can then interpret the likes/dislikes associated with that piece of content. The sensors can include but not limited to cameras, microphones, health monitors and skin sensors. The processing of the data may be done in the cloud and may include metrics for likes/dislikes such as humor, attention, boredom, anxiety, etc. An algorithm can, using the metrics, calculate an appropriate rating such as number of stars, likes/dislikes, associations, etc. and post it on the user's behalf along with the content. It can also be provided to the content provider as feedback. The automated feedback may further be used for automatic ingestion of ratings for viewed events, such as movies, commercials, products, etc., thereby eliminating human interpretation.

Accordingly, a device includes at least one computer readable storage medium bearing instructions executable by a processor, and at least one processor configured for accessing the computer readable storage medium to execute the instructions to configure the processor for receiving, from an imager and/or a microphone, at least one emotion signal representing at least one expression of a user of a consumer electronics (CE) device. The processor receives, from a biometric sensor, at least one biometric signal representing at least one biometric parameter of a user of the CE device, and based at least in part on the emotion signal and biometric signal, determines a rating related to content presented on the CE device at or near the time the emotion signal and biometric signal were generated.

The device can be the CE device and the processor can be in the CE device. Or, the device can be established at least in part by a network server separate from the CE device and receiving signals therefrom.

In examples, the biometric sensor is a first biometric sensor, the biometric signal is a first biometric signal, the biometric parameter is a first biometric parameter, and the processor when executing the instructions is further configured for receiving, from a second biometric sensor, at least a second biometric signal representing at least a second biometric parameter of a user of the CE device. Based at least in part on the emotion signal and the first and second biometric signals, the processor determines the rating.

In some embodiments, the processor when executing the instructions is further configured for outputting for presentation on a display device a “like” and/or a “dislike” signal based at least in part on the rating. The processor when executing the instructions may be further configured for generating an automatic message to a user identified by means of a message presented on the CE device related to the rating, and responsive to user selection, sending the automatic message to the user identified by means of the message presented on the CE device related to the rating. The processor when executing the instructions can be further configured for providing a user of the CE device an option to add a personal user-generated message to the automatic message, and providing a user of the CE device an option to replace the automatic message with the personal user-generated message.

In another aspect a method includes receiving emotion signals derived from an audio and/or video image of a user of a consumer electronics (CE) device, and/or receiving biometric signals derived from at least one biometric sensor coupled to the user of the CE device. Based at least in part on the emotion signals and/or biometric signals, a “like” and/or a “dislike” signal is generated for presentation, on a display, of a “like” and/or a “dislike” icon and/or message on the display.

In another aspect, a system has at least one computer readable storage medium bearing instructions executable by a processor which is configured for accessing the computer readable storage medium to execute the instructions to configure the processor for presenting on a display a user interface (UI). The UI may include a name of a content, a “like” icon, and an indication of other users who liked the content. The UI may also include a “dislike” icon and an indication of other users who disliked the content. A selector is selectable to cause a name of a user associated the “like” or “dislike” icon to appear on the display.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is flow chart of example overall logic;

FIGS. 3-5 are example user interfaces (UI) according to present principles; and

FIG. 6 is a table showing example expression and biometric information-to-rating correlations.

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

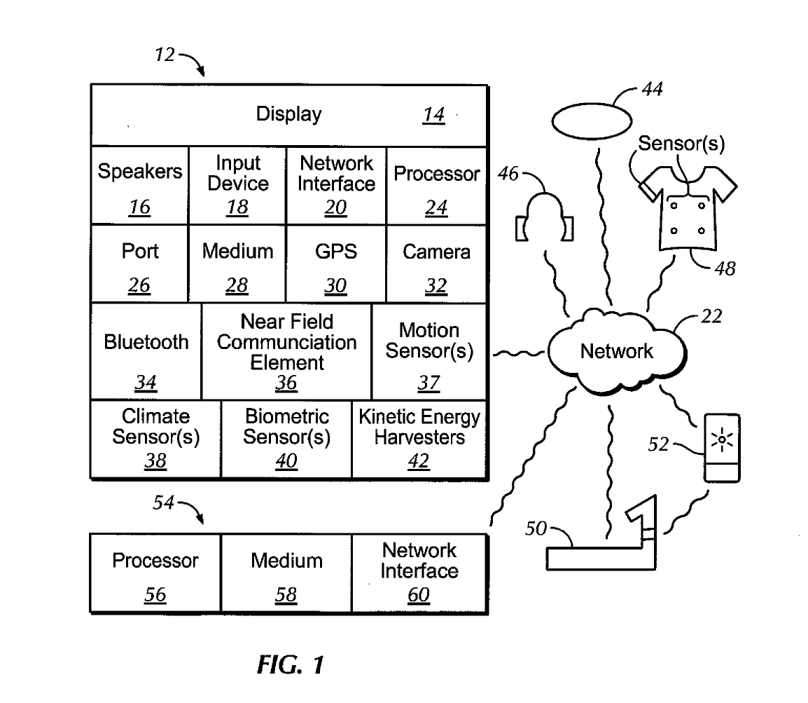

Now specifically referring to FIG. 1, an example system 10 is shown, which may include one or more of the example devices mentioned above and described further below in accordance with present principles. The first of the example devices included in the system 10 is an example consumer electronics (CE) device 12 that may be waterproof (e.g., for use while swimming). The CE device 12 may be, e.g., a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc., and even e.g. a computerized Internet-enabled television (TV). Regardless, it is to be understood that the CE device 12 is configured to undertake present principles (e.g. communicate with other CE devices to undertake present principles, execute the logic described herein, and perform any other functions and/or operations described herein).

Accordingly, to undertake such principles the CE device 12 can be established by some or all of the components shown in FIG. 1. For example, the CE device 12 can include one or more touch-enabled displays 14, one or more speakers 16 for outputting audio in accordance with present principles, and at least one additional input device 18 such as e.g. an audio receiver/microphone for e.g. entering audible commands to the CE device 12 to control the CE device 12 or one or more keyed entry or point and click entry devices. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, WiFi transceiver, etc.

In addition to the foregoing, the CE device 12 may also include one or more input ports 26 such as, e.g., a USB port to physically connect (e.g. using a wired connection) to another CE device and/or a headphone port to connect headphones to the CE device 12 for presentation of audio from the CE device 12 to a user through the headphones. The CE device 12 may further include one or more tangible computer readable storage medium 28 such as disk-based or solid state storage, it being understood that the computer readable storage medium 28 may not be a carrier wave. Also in some embodiments, the CE device 12 can include a position or location receiver such as but not limited to a GPS receiver and/or altimeter 30 that is configured to e.g. receive geographic position information from at least one satellite and provide the information to the processor 24 and/or determine an altitude at which the CE device 12 is disposed in conjunction with the processor 24. However, it is to be understood that that another suitable position receiver other than a GPS receiver and/or altimeter may be used in accordance with present principles to e.g. determine the location of the CE device 12 in e.g. all three dimensions.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles. Also included on the CE device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the CE device 12 may include one or more motion sensors 37 (e.g., an accelerometer, gyroscope, cyclometer, magnetic sensor, infrared (IR) motion sensors such as passive IR sensors, an optical sensor, a speed and/or cadence sensor, a gesture sensor (e.g. for sensing gesture command), etc.) providing input to the processor 24. The CE device 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. Biometric sensors disclosed herein may include, without limitation, pulse or heart rate sensors, body temperature sensors, perspiration sensors, blood pressure sensors, pupil size sensors, eye direction sensors. In addition to the foregoing, it is noted that in some embodiments the CE device 12 may also include a kinetic energy harvester 42 to e.g. charge a battery (not shown) powering the CE device 12.

Still referring to FIG. 1, in addition to the CE device 12, the system 10 may include one or more other CE device types such as, but not limited to, a computerized Internet-enabled bracelet 44, computerized Internet-enabled headphones and/or ear buds 46, computerized Internet-enabled clothing 48, a computerized Internet-enabled exercise machine 50 (e.g. a treadmill, exercise bike, elliptical machine, etc.), etc. Also shown is a computerized Internet-enabled entry kiosk 52 permitting authorized entry to a space. It is to be understood that other CE devices included in the system 10 including those described in this paragraph may respectively include some or all of the various components described above in reference to the CE device 12 such but not limited to e.g. the biometric sensors and motion sensors described above, as well as the position receivers, cameras, input devices, and speakers also described above.

Now in reference to the afore-mentioned at least one server 54, it includes at least one processor 56, at least one tangible computer readable storage medium 58 that may not be a carrier wave such as disk-based or solid state storage, and at least one network interface 60 that, under control of the processor 56, allows for communication with the other CE devices of FIG. 1 over the network 22, and indeed may facilitate communication between servers and client devices in accordance with present principles. Note that the network interface 60 may be, e.g., a wired or wireless modem or router, WiFi transceiver, or other appropriate interface such as, e.g., a wireless telephony transceiver.

Accordingly, in some embodiments the server 54 may be an Internet server, may include and perform “cloud” functions such that the CE devices of the system 10 may access a “cloud” environment via the server 54 in example embodiments.

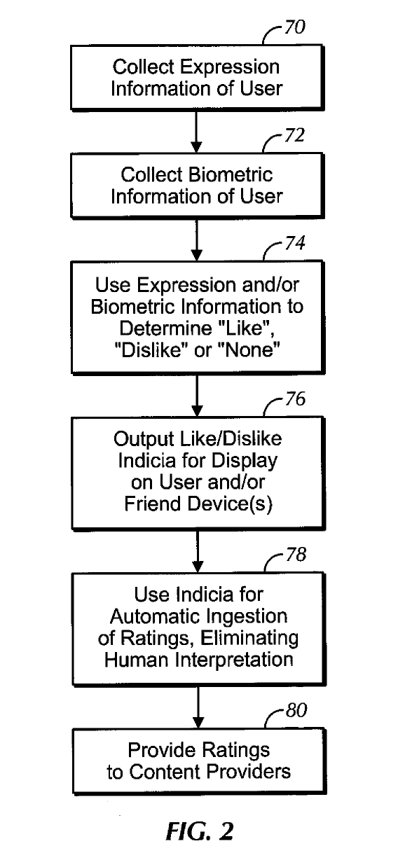

Now referring to FIG. 2, at block 70 expression information is collected from a user of a CE device such as the CE device 12, for example by imaging the user's face and/or recording the user's voice using the camera and microphone described above. Biometric information of the user may also be collected at block 72 using any of the sensors 40 on the CE device or those on clothing 48 (FIG. 1) or other biometric sensors. As mentioned previously, such biometric information may include heart or pulse rate, perspiration level, temperature, blood pressure, blood sugar level, blood oxygen level. Note that along with the expression information and biometric information, the processor of the CE device can append information indicating subject matter being presented on the CE device at the time the expression and/or biometric information was imaged/recorded, such as a network address of a web content source or channel of a TV station being viewed.

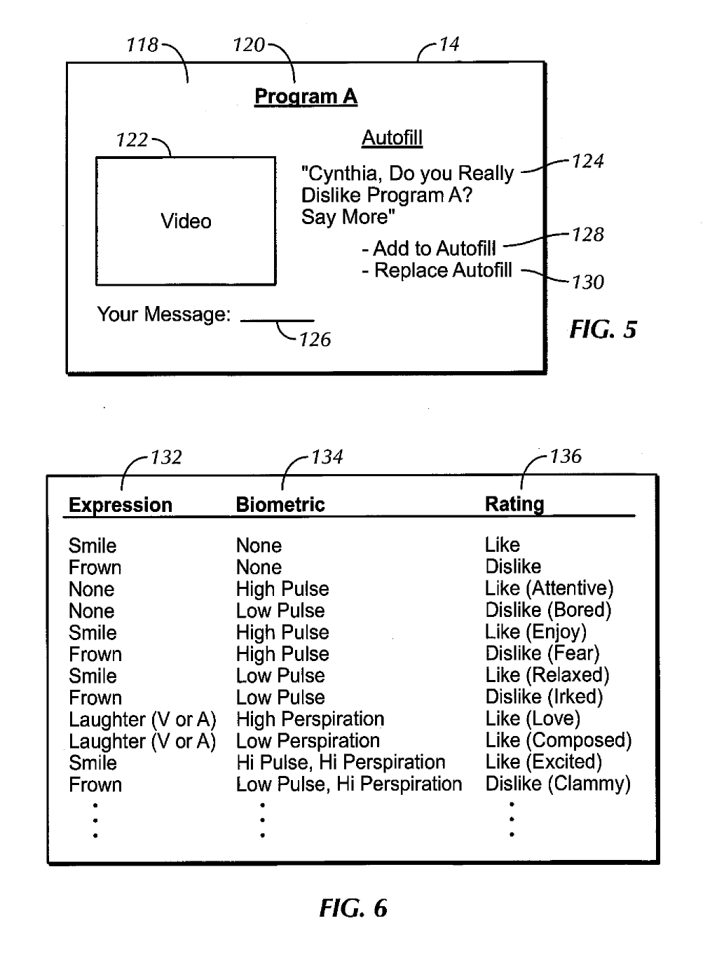

Then, at block 74 the expression and/or biometric information may be correlated to determinations of ratings as to whether the user likes or dislikes what he is viewing on the CE device. To do this, facial recognition is employed on images of the user's face to determine whether the user is frowning, laughing, smiling, crying, etc., i.e., facial recognition software processes the image to output an expression, such as “smile”. In addition or alternatively, voice recognition is employed on audio recording of sounds made by the user to determine whether the user is laughing, crying, speaking loudly, speaking softly, etc., i.e., voice recognition software processes the user's audio to output an expression, such as “laughing” or “crying”. An example non-limiting correlation table that can be accessed to undertake the logic at block 74 is shown in FIG. 6, discussed further below.

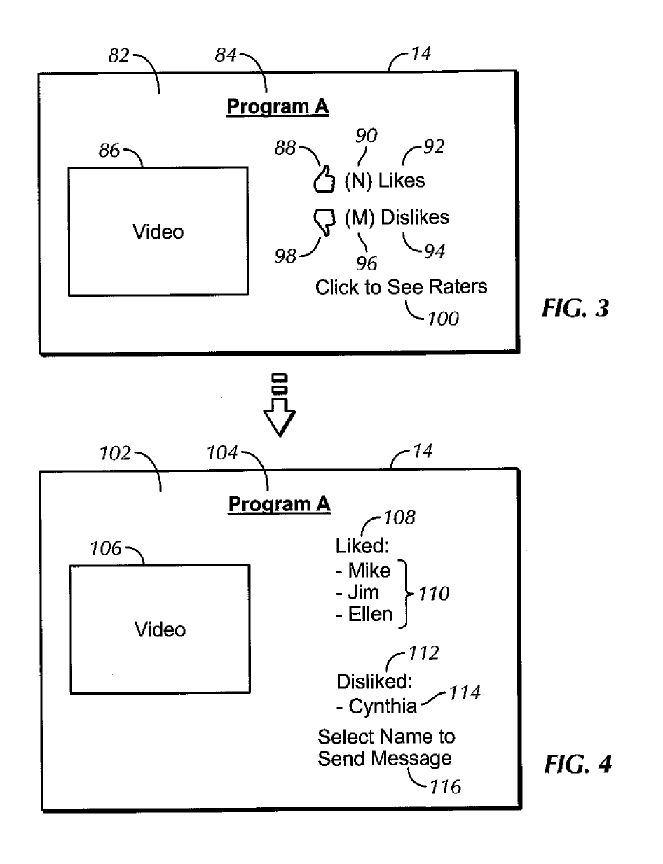

Once the rating indicia have been determined at block 74, they can be grouped by content titles to which they pertain and output at block 76 to the CE device and/or to devices of social networking friends of the user of the CE device and/or to other devices for display. The grouping may be done by the CE device receiving friend device information peer-to-peer or through a network and/or by a cloud server receiving rating information from both the CE device 12 and other devices, including devices of social networking friends of the user of the CE device 12. Example displays are shown in FIGS. 3-5 and discussed further below. Also, at block 78 the rating indicia can be used for automatic ingestion of ratings from multiple users viewing the same content, eliminating human interpretation of user images, comments, and the like. Ratings may be provided at block 80 to the providers of the content whose identification (which typically includes the content source) accompanies the collected user information at blocks 70 and 72 as discussed above.

Note that while the CE device processor normally collects information at blocks 70 and 72, the ensuing logic in FIG. 2 may be performed by the CE device processor and/or by a cloud server that receives from the CE device processor the information collected at blocks 70 and 72.

FIG. 3 shows an example user interface (UI) 82 that may be presented on, e.g., the display 14 of the CE device 12 to illustrate to the user how many of his social network friends like and dislike a content being presented on the CE device 12. It is to be understood for illustration that the likes and dislikes of the friends as shown in FIG. 3 are gathered and determined from the friend devices using the logic of FIG. 2 as executed on the devices of the friends and/or as executed in concert with cloud-based determinations as mentioned previously.

As shown in FIG. 3, a content name 84 and associated content 86 may be presented on the display 14. The content 86 may be video and/or audio. A “like” icon 88 such as an image of a hand with thumb up may be presented along with an integer number 90 indicating the number of other users who liked the content 86. A text indication 92 can further inform the user that the icon 88 and number 90 pertain to “like” ratings of the content 86. As also shown in FIG. 3, additional rating information such as a row of stars (shown immediately below the number 90) may be presented indicating the strength of the like consensus, in this case, indicating either the number 90 itself or an indication of the number 90 normalized to a relative rating of, e.g., a scale from one star to five stars.

A “dislike” icon 98 such as an image of a hand with thumb down may be presented along with an integer number 96 indicating the number of other users who disliked the content 86. A text indication 94 can further inform the user that the icon 98 and number 96 pertain to “dislike” ratings of the content 86. Additional rating information such as a row of stars may be presented also indicating the strength of the dislike consensus.

In some examples a link 100 may be presented on the UI 82 enabling a user to select the link to view the names of the rating friends whose accumulated ratings are shown in FIG. 3. Clicking on the link 100 may cause the UI 102 of FIG. 4 to appear, in which a content name 104 (typically the same as the name 84 shown in FIG. 3) and associated content 106 (typically the same as the content 86 shown in FIG. 3) may be presented on the display 14. Under a heading 108 indicating the “liked” rating, names 110 of other users who were evaluated from their expression and/or biometric information as liking the content 106 are shown. Likewise, under a heading 112 indicating the “disliked” rating, names 114 of other users who were evaluated from their expression and/or biometric information as liking the content 106 are shown. A message 116 may be presented informing a user of the CE device 12 to select a name 110 or 114 to send a message to the associated user device. Selecting a name may cause the UI 118 of FIG. 5 to appear.

As shown in FIG. 5, a content name 120 (typically the same as the name 84 shown in FIG. 3) and associated content 122 (typically the same as the content 86 shown in FIG. 3) may be presented on the display 14. An automatically generated message 124 may be presented on the display using the name selected from FIG. 4, the category under which the name appeared, and the name of the content 122. Thus, in the example shown, the user had selected the name “Cynthia” from FIG. 4 and the CE device processor then automatically generated the message 124 using the name “Cynthia”, the category “dislike” under which the name “Cynthia” appeared in FIG. 4, and the name 20 of the program to which “Cynthia's” rating appertained.

Additionally, if desired the user may be given the option to enter his own personalized message into entry 128 and then select 128 to append the personalized message to the autofill message 124, or to replace 130 the autofill message 124 with the personalized message.

FIG. 6, alluded to previously, shows an example table heuristically correlating expressions 132 (as collected, e.g., at block 70 of FIG. 2) and biometric data 134 (as collected, e.g., at block 72 of FIG. 2) of a user to ratings 136. It is to be understood that additional and/or other correlation heuristics may be used. The first two entries in FIG. 6 show that expression information from user face and/or voice image recognition may be used to correlate to a rating without using biometrics. In the example shown, a smile is correlated to a “like” and a frown is correlated to a “dislike”. On the other hand, the third and fourth entries in FIG. 6 show that biometric information only may be used to correlate to a rating, in the example shown, “high pulse” rate (e.g., a pulse rate above a threshold rate) may be correlated to “like” while a “low pulse” rate (e.g., a pulse rate below a threshold rate) may be correlated to a “dislike” rating.

Yet again, rating correlation rules may be applied to a combination of expression and biometric information. Thus, as exemplified in the fifth entry of FIG. 6, a smile with a high pulse rate may be correlated to a “like” along with, if desired, a qualitative index for the rating, in the example shown, “enjoy”. In contrast, in the sixth entry of FIG. 6, a frown with a high pulse rate may be correlated to a “dislike” along with, if desired, a qualitative index for the rating, in the example shown, “fear”. The remaining entries in the example table of FIG. 6 show combination of expressions and biometric parameters and their correlations to ratings and respective qualitative indicia of those ratings. For example, an expression and plural biometric parameters in combination may be correlated to a rating.

While the particular COMPUTER ECOSYSTEM WITH AUTOMATIC “LIKE” TAGGING is herein shown and described in detail, it is to be understood that the subject matter which is encompassed by the present invention is limited only by the claims.

What is claimed is:

1. A device comprising:
at least one computer readable storage medium bearing instructions executable by a processor;
at least one processor configured for accessing the computer readable storage medium to execute the instructions to configure the processor for:
receiving, from an imager and/or a microphone, at least one emotion signal representing at least one expression of a user of a consumer electronics (CE) device;
receiving, from a biometric sensor, at least one biometric signal representing at least one biometric parameter of a user of the CE device; and
based at least in part on the emotion signal and biometric signal, determining a rating related to content presented on the CE device at or near the time the emotion signal and biometric signal were generated.

2. The device of claim 1, wherein the device is the CE device and the processor is in the CE device.

3. The device of claim 1, wherein the device is established at least in part by a network server separate from the CE device and receiving signals therefrom.

4. The device of claim 1, wherein the biometric sensor is a first biometric sensor, the biometric signal is a first biometric signal, the biometric parameter is a first biometric parameter, and the processor when executing the instructions is further configured for:
receiving, from a second biometric sensor, at least a second biometric signal representing at least a second biometric parameter of a user of the CE device; and
based at least in part on the emotion signal and the first and second biometric signals, determining the rating.

5. The device of claim 1, wherein the processor when executing the instructions is further configured for:
outputting for presentation on a display device a “like” and/or a “dislike” signal based at least in part on the rating.

6. The device of claim 1, wherein the processor when executing the instructions is further configured for:
generating an automatic message to a user identified by means of a message presented on the CE device related to the rating; and
responsive to user selection, sending the automatic message to the user identified by means of the message presented on the CE device related to the rating.

7. The device of claim 6, wherein the processor when executing the instructions is further configured for:
providing a user of the CE device an option to add a personal user-generated message to the automatic message.

8. The device of claim 7, wherein the processor when executing the instructions is further configured for:
providing a user of the CE device an option to replace the automatic message with the personal user-generated message.

9. Method comprising:
receiving emotion signals derived from an audio and/or video image of a user of a consumer electronics (CE) device, and/or receiving biometric signals derived from at least one biometric sensor coupled to the user of the CE device; and
based at least in part on the emotion signals and/or biometric signals, generating a “like” and/or a “dislike” signal for presentation, on a display, of a “like” and/or a “dislike” icon and/or message on the display.

10. The method of claim 9, wherein the display is a display of the CE device.

11. The method of claim 9, wherein the display is a display of a device of a social network friend of the user of the CE device.

12. The method of claim 9, wherein the method is implemented by the CE device, and the emotion and/or biometric signals are received from respective sensors communicating with the CE device.

13. The method of claim 9, wherein the method is implemented by a network server, and the emotion and/or biometric signals are received from the CE device.

14. System comprising:
at least one computer readable storage medium bearing instructions executable by a processor which is configured for accessing the computer readable storage medium to execute the instructions to configure the processor for:
presenting on a display a user interface (UI) comprising:
at least one name of at least one content;
at least one “like” icon;
at least one indication of other users who liked the content;
at least one “dislike” icon;
at least one indication of other users who disliked the content; and
at least one selector selectable to cause at least one name of a user associated the “like” or “dislike” icon to appear on the display.

15. The system of claim 14, wherein the UI further comprises an indication of an integer number of users associated with the “like” icon.

16. The system of claim 14, wherein the UI further comprises a row of indicator elements indicating a strength of a “like” consensus associated with the “like” icon.

17. The system of claim 14, wherein the processor when executing the instructions is further configured for presenting on the display in response to selection of the selector a sub-UI listing names of other users associated with the “like” and/or “dislike” icons.

18. The system of claim 17, wherein the processor when executing the instructions is further configured for presenting on the display in response to selection of a name on the sub-UI a sub-sub-UI facilitating sending a message to a device associated with a name selected from the sub-UI.

19. The system of claim 18, wherein the message is an automatically generated message based at least in part on the name selected from the sub-UI, a “like” or “dislike” category with which the name selected from the sub-UI is associated, and a content title.

20. The system of claim 19, wherein the sub-sub-UI further includes elements affording a user an option of sending the automatically generated message with a user-generated message.
